(19) United States
(12) Patent Application Publication
(10) Pub. No.: US 2011/0109809 A1
(43) Pub. Date: May 12, 2011

(54) ELECTRONIC DEVICE AND AUTOMATIC TURNOFF METHOD FOR THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/819,386

(22) Filed: Jun. 21, 2010

(30) Foreign Application Priority Data
Nov. 6, 2009 (CN) 200910309397.1

(51) Int. Cl. H04N 5/63

(52) U.S. Cl. 348/730; 348/E05.127

(57) ABSTRACT

An electronic device includes a power managing unit configured to supply power to the electronic device. A receiver adapted to receive program signals, wherein the program signals comprises at least one composite video signal. A processor configured for obtaining the composite video signal from the program signals according to a selected program/channel, and processing the composite video signal to directly output the composite video signal. An automatic turnoff unit electrically connected to the processor and the power managing unit, configured to detect whether the composite video signal has been interrupted for a predetermined time interval and control the power managing unit to power off the electronic device if the composite video signal has been interrupted for the predetermined time interval. A related automatic turnoff method for automatically turning off an electronic device is also disclosed.

### BACKGROUND

1. Technical Field

The present disclosure generally relates to electronic devices, and particularly to automatic turnoff methods used by electronic devices.

2. Description of Related Art

Electronic devices such as televisions, computers, audio and video players, and mobile phones, are now very commonly used. People often like to watch television, download large files on a computer, or listen to music when they are going to sleep. However, they may fall asleep while the device is still playing. The electronic device may continue operating even when the program has finished playing this can waste power/energy.

Therefore, an electronic device and an automatic turnoff method for the electronic device are needed in the industry to address the aforementioned problem.

### BRIEF DESCRIPTION OF THE DRAWINGS

Many aspects of the present electronic device and the present automatic turnoff method can be better understood with reference to following drawings. Components in the drawings are not necessarily to scale, emphasis instead being placed upon clearly illustrating the principles of the present device. Moreover, in the drawings, like reference numerals designate corresponding parts throughout the two views.

FIG. 1 is a block diagram of an electronic device in accordance with an exemplary embodiment.

FIG. 2 is a flowchart illustrating an automatic turnoff method in accordance with an exemplary embodiment.

### DETAILED DESCRIPTION

Reference will now be made to the drawings to describe an exemplary embodiment of the present electronic device and an exemplary embodiment of the present automatic turnoff method for automatically turning off the electronic device.

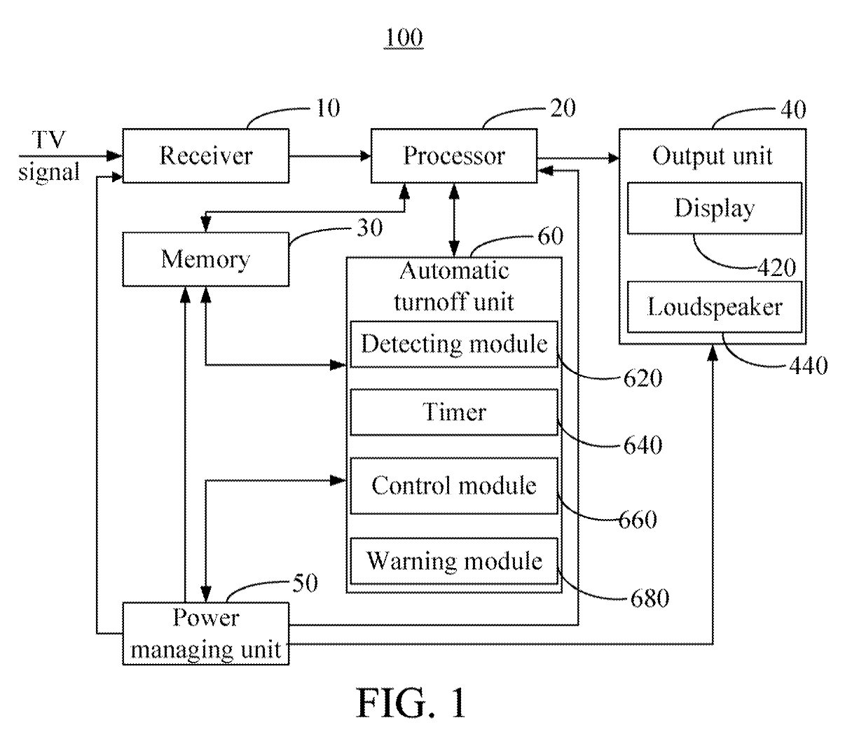

Referring to FIG. 1, a block diagram of an electronic device 100 in accordance with an exemplary embodiment is shown. The electronic device 100 includes a receiver 10, a processor 20, a memory 30, an output unit 40, a power managing unit 50 and an automatic turnoff unit 60.

The memory 30 stores an operating system, a plurality of applications, a predetermined time interval, and a plurality of default parameters, such as a predetermined luminance value. The operating system (e.g., LINUX®, UNIX®, or an embedded operating system such as VxWorks®) includes various procedures, sets of instructions, software components and/or drivers for controlling and managing general system tasks (e.g., memory management, storage device control, and power management, etc.) and facilitating communication between various hardware and software components.

The electronic device 100 may be a television apparatus, a computer, an audio or video player. In this embodiment, the electronic device 100 is a television apparatus (hereinafter, TV). The receiver 10 is used for receiving TV signals, which may be transmitted in a wired or wireless manner. The TV signals include a composite video signal and an audio signal. The composite video signal includes sync, luminance, black and white, and color information.

The processor 20 is used to obtain the composite video signal and the audio signal from the received TV signals corresponding to a selected program or channel, and to process the composite video signal and the audio signal such that the composite video signal and the audio signal are capable of being directly output by the output unit 40. When the receiver 10 receives no TV signal for a predetermined time interval, such as 60 seconds, the processor 20 obtains no composite video signal and no audio signal for 60 seconds, the processor 20 can conclude the TV may need to be turned off.

The output unit 40 is used to output the composite video signal and audio signal that is processed by the processor 20. In the embodiment, the output unit 30 includes a display 410 and a loudspeaker 420. The display 410 is configured to display the processed composite video signal, and the loudspeaker 420 is configured to output the audio signal synchronously.

The power managing module 50 is configured to obtain voltage from a power supply (not shown) and power the voltage to the TV 100.

The automatic turnoff module 60 is electrically coupled to the processor 20 and the power managing unit 50, includes a detecting module 620, a timer 640, and a control module 660.

The detecting module 420 is configured to detect whether a composite video signal has been interrupted, and generate a detecting signal if the composite video has been interrupted. In the embodiment, when the receiver 10 receives no TV signal, the processor 20 obtains no composite video signals, and an interrupt of the composite video signal is said to have occurred. It is noteworthy that when the luminance value of the composite video signal is lower than a predetermined value, the composite video signal is also read as interrupted.

The timer 440 is configured to time and signal the end of the predetermined time interval by outputting a time end signal to the control module 460.

The control module 460 is configured to generate a turnoff signal in response to the time end signal, and control the power managing module 50 to power off the TV 100 according to turnoff signal. In detail, when the detecting module 720 detects that the composite video signal has been interrupted, the timer 740 times the time interval and sends the time end signal to the control module 660, and the control module 660 generates a turnoff signal to turn-off the power managing module 50, thereby automatically turning off the TV 100. If the composite video signal has been interrupted for the predetermined time interval.

Furthermore, the automatic turnoff unit 60 further comprises a warning module 680, the memory 30 further stores a warning file. The warning file includes various instructions being executed by the processor 20 of the TV 100 to warn a user that a special situation occurs. The warning module 680 is used for generating a warning signal and sending the warning signal to the processor 20 based on the warning file when the composite video signal has been interrupted. The warning signal may be an audible signal sound or an indication query “Are you falling asleep?” The processor 20 controls the loudspeaker 440 set in the TV 100 to output the audio signal to warn the sleeping user that the composite video signal has been interrupted. In additional, the volume of the audible sound should be low enough that a sleeping user is not awakened. It is noteworthy that the warning signal can also be a visible signal. For example, the warning signal may be a cartoon or some other pleasing image asking “Are you falling asleep?”, and the processor 20 may control the display 410 to output the visible signal. If the user is not asleep or has not left, he or she may follow a direction or directions displayed on the display unit 410 to respond to the warning signal via an input unit (not shown), such as a remote controller.

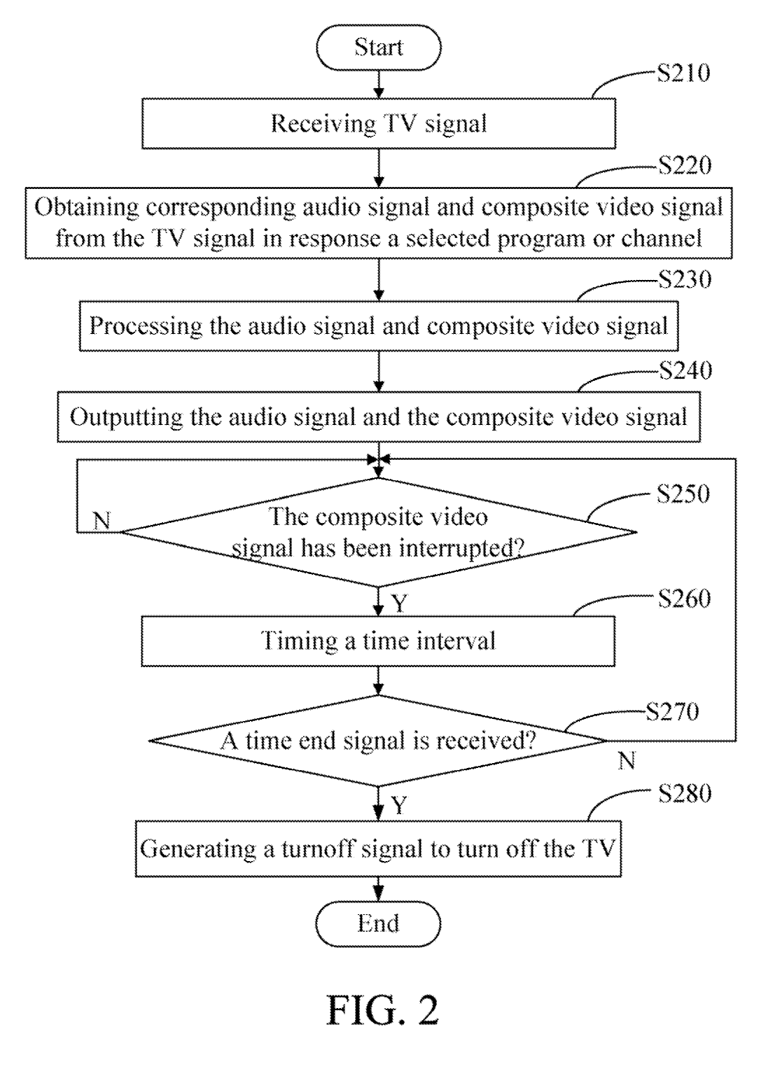

Referring to FIG. 2, a flow chart for an automatic turnoff method is shown in accordance with an exemplary embodiment. The automatic turnoff method is for automatically turning off the TV 100. The automatic turnoff method includes the following steps.

At step S210, the receiver 10 receives a TV signal, the TV signal includes a composite video signal and an audio signal.

At step S220, the processor 20 obtains the corresponding audio signal and the composite video signal from the received TV signal according to a selected program or channel.

At step S230, the processor 20 processes the audio signal and composite video signal such that the output unit 40 is capable of directly outputting the audio signal and composite video signal.

At step S240, the processor 20 further controls the output unit 40 and synchronously outputs the audio signal and the composite video signal that has been processed by the processor 20.

At step S250, the detecting module 620 detects whether the composite video signal has been interrupted, if no, the procedure returns to S250, and if yes, the detecting module 620 further generates a detecting signal to the control module 660, and the procedure goes to step S260.

At step S260, if there is a detecting signal generated, the control module 660 controls the timer 640, to time and signal the end of the predetermined time interval by outputting a time end signal.

At step S270, the control module 660 judges whether the time end signal is received, if no, the procedure returns to step S250, and if yes, the composite video signal has been interrupted for the predetermined time interval, the procedure goes to step S280.

At step S280, the control module 660 generates a turnoff signal to control the power managing unit 50 power off the TV 100.

As described above, by virtue of the TV 100 and the automatic turnoff method applied thereon, when the composite video signal has been interrupted for a predetermined time interval, the TV 100 is automatically turned off even if a the user is sleeping or not, to save electrical power.

It should be noted that the various steps in the method illustrated in FIG. 2 may be performed in the order presented, or may be performed in a different order. Furthermore, in some embodiments, some steps can be added to the method, for example, when the detecting module 620 generates a detecting signal to the control module 660, the control module 660 controls the warning module 680 to generate a warning signal to the processor 20. The processor 20 controls the display 420 and/or the loudspeaker 440 to output a warning signal, such as a visual signal, an audio signal, or a combination of the visual signal and audio signal, to warn the user that the composite video signal has been interrupted.

It should be emphasized that the above-described preferred embodiment, is merely a possible example of implementation of the principles of the disclosure, and is merely set forth for a clear understanding of the principles of the disclosure. Many variations and modifications may be made to the above-described embodiment of the invention without departing substantially from the spirit and principles of the disclosure. All such modifications and variations are intended to be included herein within the scope of this disclosure and be protected by the following claims.

What is claimed is:

1. An electronic device comprising:
a power managing unit configured to supply power to the electronic device;
a receiver adapted to receive program signals, wherein the program signals comprises at least one composite video signal;
a processor configured for obtaining the composite video signal from the program signals according to a selected program/channel, and processing the composite video signal so as to directly output the composite video signal; and
an automatic turnoff unit electrically connected to the processor and the power managing unit, configured to detect whether the composite video signal has been interrupted for a predetermined time interval and control the power managing unit to power off the electronic device if the composite video signal has been interrupted for the predetermined time interval.

2. The electronic device according to claim 1, wherein the program signals further comprises an audio signal.

3. The electronic device according to claim 2, further comprising an outputting unit, wherein the output unit is configured to output the composite video signal and the audio signal.

4. The electronic device of claim 1, wherein the automatic turnoff unit comprises a detecting module, a timer and a control module, the detecting module is configured to detect whether the composite video signal has been interrupted and generate a detecting signal if the composite video signal has been interrupted, the timer is configured to time and signal the end of the predetermined time interval by outputting a time end signal to the control module after a detecting signal is generated, and the control module is configured to generate a turnoff signal to turn off the power managing unit in response to the time end signal.

5. The electronic device of claim 4, wherein the automatic turnoff unit further comprises a warning module, the warning module is configured to generate a warning signal after a detecting signal is generate, so as to warn a user that an interrupt of composite video signal is occurred.

6. The electronic device of claim 5, wherein the warning signal is one of an audible, a visible signal, and a combination of an audio signal and a visible signal.

7. The electronic device of claim 1, further comprising a memory, wherein the memory is configured for storing the predetermined time interval.

8. An automatic turnoff method, for automatically turning off an electronic device, comprising:
receiving program signals, wherein the program signals comprises at least composite video signal;
obtaining composite video signal from the program signals in response to a selected program/channel;
detecting whether the composite video signal has been interrupted for a predetermined time interval; and
turning off the electronic device if the composite video signal has been interrupted for the predetermined time interval.

9. The automatic turnoff method of claim 8, further comprising:
processing the program signals; and
directly outputting the processed program signals.

10. The automatic turnoff method of claim 8, further comprising:
generating a detecting signal if the composite video signal has been interrupted;
timing and signaling the end of the predetermined time interval by outputting a time end signal after the detecting signal is generated; and
generating a turnoff signal so as to turn off the electronic device.

11. The automatic turnoff method of claim 10, further comprising:
generating a warning signal after the detecting signal is generated; and
outputting the warning signal to warn a user that an interrupt of composite video signal is occurred.

12. The automatic turnoff method of claim 11, wherein the warning signal is one of an audible, a visible signal, and a combination of an audio signal and a visible signal.

13. An electronic device, comprising:
a power managing unit adapted to supply electrical power to the electronic device;
a receiver adapted to receiving external signals;
a detecting module adapted to detect whether the receiver receives no external signals for a predetermined time interval, and generate a detecting signal when the receiver receives no external signals for the predetermined time interval; and
a control module adapted to generating a turnoff signal responding to the detecting signal, and transmitting the turnoff signal to the power managing unit;
wherein the power managing unit powers off the electronic device in response to the turnoff signal.

14. The electronic device according to claim 13, wherein the external signals further comprises an audio signal and a composite video signal.

15. The electronic device according to claim 14, further comprising an output unit, wherein the output unit is configured to output the composite video signal and the audio signal.

16. The electronic device of claim 13, further comprising a timer, wherein the timer is configured to time and signal the end of the predetermined time interval by outputting a time end signal to the control module if the detecting module detects that the external signals has been interrupted for the predetermined time interval.

17. The electronic device of claim 13, further comprising a warning module, wherein the warning module is configured to generate a warning signal after a detecting signal is generate, so as to warn a user that an interrupt of composite video signal is occurred.

18. The electronic device of claim 17, wherein the warning signal is one of an audible, a visible signal, and a combination of an audio signal and a visible signal.

19. The electronic device of claim 13, further comprising a memory, wherein the memory is configured for storing the predetermined time interval.
